(19) United States
(12) Patent Application Publication
(10) Pub. No.: US 2006/0026497 A1
(43) Pub. Date: Feb. 2, 2006

(54) Apparatus and method for directing user to internet resource

(75) Inventors: D. Kimble Haenlein, Carmel, CA (US); Keiko Okubo, Carmel, CA (US)

Correspondence Address: SUGHRUE MION, PLLC, 401 Castro Street, Ste 220, Mountain View, CA, 94041-2007, US

(73) Assignee: GLOBALMINDS INTERNET, INC., Carmel, CA (US)

(21) Appl. No.: 11/224,901

(22) Filed: Sep. 12, 2005

Related U.S. Application Data
(60) Provisional application No. 60/611,363, filed on Sep. 19, 2004.

(51) Int. Cl. G06F 17/24; G06F 17/21; G06F 17/30; G06F 3/00; G06F 17/00

(52) U.S. Cl. 715/501.1; 715/513; 707/10; 715/764

(57) ABSTRACT

The invention allows a user to directly access multiple Internet resources by activating predetermined areas within a single banner ad with a single click. The inventive graphical advertising object contains embedded links to multiple Internet resources. Each such link may be associated with a specific graphical primitive within the graphical advertising object. When the user activates the particular primitive, the user's browser is re-directed not simply to the home web page of the advertiser's web site, but to the specific resource, product or service within that web site. The invention obviates the need for the user to navigate within the advertiser's web site after the user clicks on the banner ad. Alternatively the specific resource, product or service within the advertiser's web site may be determined according to the portion of the advertising object activated by the user.

### CROSS-REFERENCE TO RELATED PATENT APPLICATIONS

This patent application relies upon and claims the benefit of U.S. Provisional Patent Application No. 60/611,363, entitled “Apparatus And Method For Directing User To Internet Resource,” filed Sep. 19, 2004, which is incorporated herein by reference in its entirety.

### FIELD OF THE INVENTION

The present invention generally relates to the filed of electronic communications by means of computer networks. More specifically, this invention relates to providing multiple links within a web object.

### DESCRIPTION OF THE RELATED ART

The global computer network called Internet (also called “World Wide Web” or just “Web”) has become one of the most widely used technologies of our time. Internet enables instant access of virtually unlimited number of users to distributed information resources that can be located anywhere on the global network. Typically, Internet users access resources by means of a program, called “browser” or “client”, which connects to an Internet server hosting the desired information via, for example, an HTTP protocol. To locate the target resources, the aforementioned browser programs include a facility for inputting an “Internet address” of the desired web resource (also called the Uniform Resource Locator (URL)), which enables the browser to connect to a desired Internet web page located at a remote site.

As an alternative to inputting the Internet address of the desired resource into browser every time, the web pages also provide facilities for automatic browser forwarding by means of web links. Specifically, the user may simply click on such a link and the user's browser will be automatically redirected to the target web page.

Many web pages use web links for providing advertising materials to the Internet users. Specifically, the web user would see an image, embedded into a web page with the content of the ad. If the user becomes interested in the ad and clicks on it, the user's web browser would be automatically re-directed to the home page or any other single specific web page within the advertiser's web site. Such advertisings are called “banner ads”.

Once user reaches the home page of advertiser's website, the user needs to further navigate within that site to locate the information, service or products that he or she desires. To this end, the user may be required to click on several additional links and/or buttons.

While the described conventional technique for providing and handling graphical advertising materials to web users accomplishes its main purpose, it requires from the Internet user additional effort to navigate from the advertiser's home web page to the web page within advertiser's website containing the information, service or product that the user desires.

Thus, the existing web navigation methods are deficient in their ability to provide for an instant access to the desired resource within advertiser's website by a single click on the banner ad.

### SUMMARY OF THE INVENTION

The present invention is directed to methods and systems that substantially obviate one or more of the above and other problems associated with conventional techniques for directing a user to a network resource.

One aspect of the inventive concept is a method, computer programming product and computer system for re-directing user's browser to a network resource. According to the inventive technique, a graphical advertising object is displayed on the user's browser. The displayed object includes a number of graphical primitives, each linked to a network resource. When the user activates the specific primitive, the link associated with the activated graphical primitive is used to redirect the user's browser to the corresponding network resource.

Another aspect of the inventive methodology is a method, computer programming product and computer system for re-directing user browser to a network resource. According to the inventive methodology, a graphical advertising object is displayed on the user's browser. The displayed is subdivided into portions. When the user activates the specific portion of the displayed graphical object, the information on the associated event is sent to a program executing on a remote server. The server uses the transmitted event information to determine a network resource requested by the user, and transmits the information identifying the requested network resource back to the user's browser. The browser, in turn, loads the corresponding network resource based on the received resource identifying information.

Yet another aspect of the inventive methodology is a method, computer programming product and computer system for re-directing user browser to a network resource. According to the inventive methodology, a graphical advertising object is displayed on the user's browser. The displayed is subdivided into portions. When the user activates the specific portion of the displayed graphical object, the information on the associated event is provided to a program executing on user's browser. The program uses the provided event information to determine a network resource requested by the user, and furnishes the information identifying the requested network resource back to the user's browser. The browser, in turn, loads the corresponding network resource based on the received resource identifying information.

Additional aspects related to the invention will be set forth in part in the description which follows, and in part will be obvious from the description, or may be learned by practice of the invention. Aspects of the invention may be realized and attained by means of the elements and combinations particularly pointed out in the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of an inventive concept;

FIG. 2 illustrates an alternative exemplary embodiment of an inventive concept;

FIG. 3 shows a block-diagram illustrating the processing of the user event according the embodiment of the inventive methodology; and

FIG. 4 shows a block-diagram illustrating the processing of the user event according the alternative embodiment of the inventive methodology.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific implementations consistent with principles of the present invention. These implementations are described in sufficient detail to enable those skilled in the art to practice the invention and it is to be understood that other implementations may be utilized and that structural changes may be made without departing from the scope and spirit of present invention. The following detailed description is, therefore, not to be construed in a limited sense.

Conventional banner ads are inconvenient to the user because once the user clicks on the ad and is automatically re-directed to the home page or any other single specific web page within the advertiser's web site, the user is still required to take additional steps to navigate therein to reach the information resource, product or service that the user was interested in.

One embodiment of the invention provides multiple links within a single e-commerce banner ad. The inventive methodology allows a user to directly access multiple Internet resources by activating predetermined areas within a single banner ad with a single click. The inventive graphical advertising object contains embedded links to multiple Internet resources, called target resources. Each such link may be associated with a specific graphical primitive within the graphical advertising object. When the user activates the particular primitive, the user's browser is re-directed not simply to the home web page of the advertiser's web site, but to the specific resource, product or service within that web site. The invention obviates the need for the user to navigate within the advertiser's web site after the user clicks on the banner ad.

The inventive graphical advertising object may be embedded into various types of resources, including without limitation, an internet page,(web page), an instant message, e-mail, or any other appropriate viewable resource. Therefore, the term “browser”, which may be used to access such a viewable resource includes a web browser, an instant messenger, an e-mail client, a cell phone display interface or any other similar software or hardware system. Also, the linked resource need not be a web page and may be any other viewable resource.

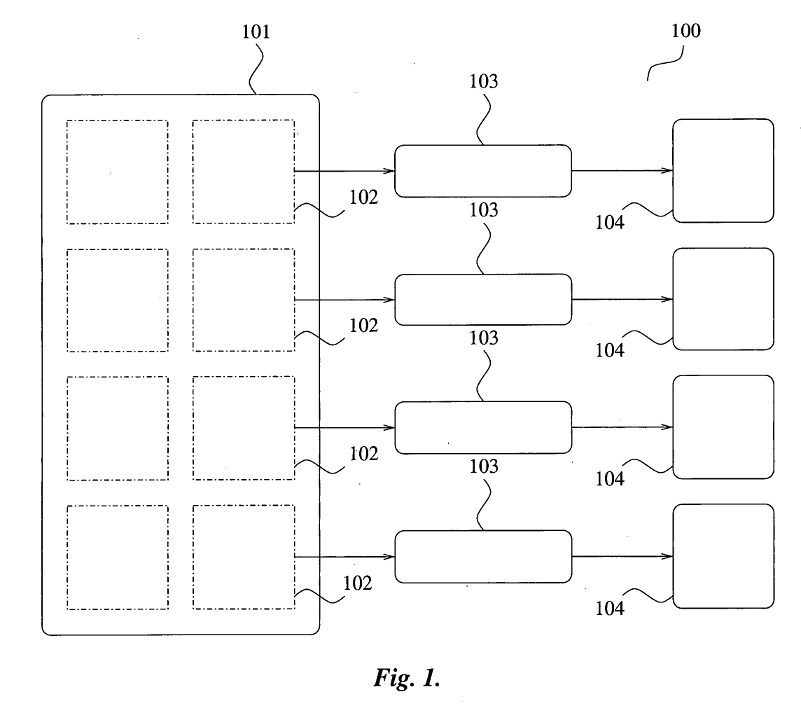

In one embodiment 100 of the inventive concept, shown in FIG. 1, the graphical banner ad 101 displayed within a viewable resource is composed of multiple graphical primitives 102. Each such graphical primitive is associated with a target resource 104 on the advertiser's web site by means of a link 103. By way of example, the banner ad may be implemented in HTML language the following manner:
<a href=“http://TargetResource1”>GraphicalPrimitive1</a>
<a href=“http://TargetResource2”>GraphicalPrimitive2</a>
<a href=“http://TargetResourceN”>GraphicalPrimitiveN</a>

In the above example, each graphical primitive GraphicalPrimitive is associated with each TargetResource by means of a link to the ULR of that target resource.

When the user activates particular primitive 102, the user's web browser is automatically re-directed to the target resource URL (104) associated with the activated primitive.

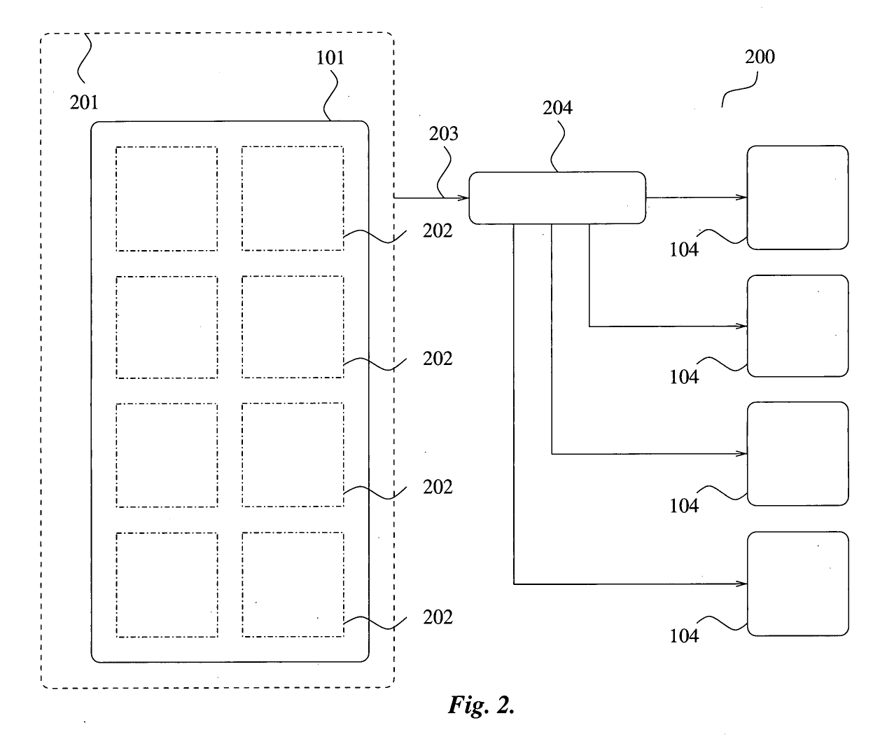

In another embodiment of inventive technique, shown in FIG. 2, the graphical banner ad 101 on the source web page, displayed by browser 201, is a single graphical object. The object is subdivided into portions 202. When the user clicks or otherwise activates the portions 202 of that object, the user's browser program 201 determines the associated event attributes, including the coordinates of the user's click within the graphical object. The aforementioned coordinates are the coordinates of the cursor on the screen at the time user pressed the mouse button. The browser thereafter transmits those coordinates (203) to a remote web server on the network. The remote web server running server program 204, in turn, determines what resource should be provided to the user based on the portion 202 of the ad activated by the user and redirects the user's browser 201 to the corresponding resource 104. This processing operation may be accomplished on the server by a variety of known techniques, for example by using CGI (Common Gateway Interface) scripts well known to persons of skill in the art. Alternatively, the described functionality may be provided by the application server software embedded into the web server on the network. This embodiment of the inventive methodology is characterized by the fact that the processing of the user event is performed on a remote server. Thus, this technique is called server-side processing. The described server-side software may be implemented using a variety of programming languages and techniques, including Perl, PHP, C, C++, Java, etc. Therefore, the specific details of the implementation of such software are not essential to the inventive concept described herein.

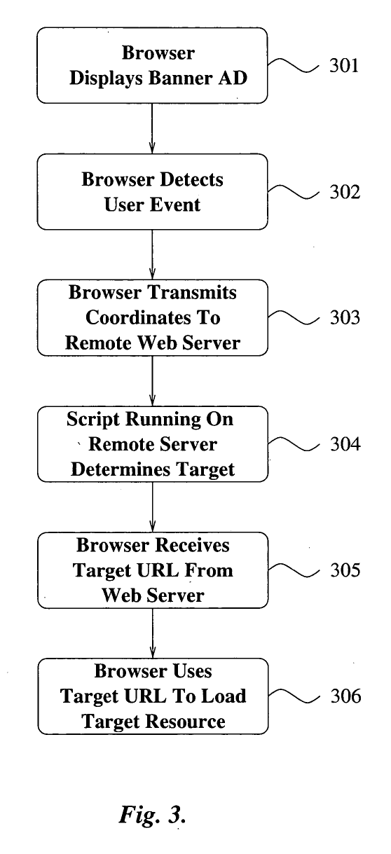

FIG. 3 shows a block-diagram illustrating the processing of the user event according the embodiment of the inventive methodology. In step 301, the user browser displays banner ad. The user's activation is the ad is detected in step 302. In step 303, the browser transmits coordinates of the user event to the remote web server, which determines the URL of the remote resource target in step 304. Subsequently, the browser receives the target URL from the web server (step 305) and uses it to load the target resource (step 306).

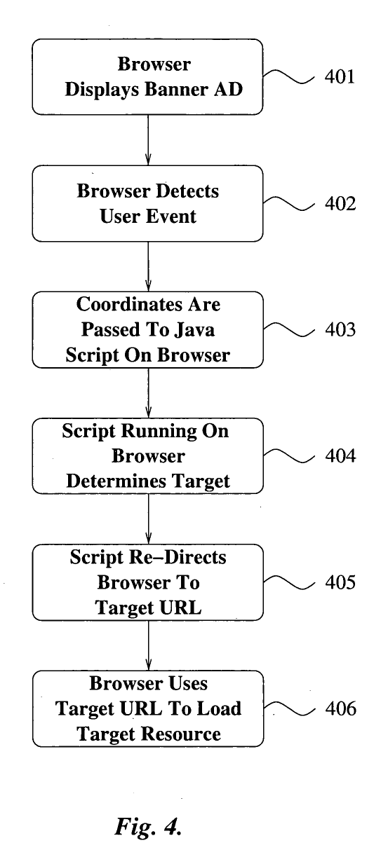

In an alternative embodiment of inventive concept, shown in FIG. 4, the user's browser also shows the banner ad (step 401) and detects the user event (step 402), but processes the entire event locally (step 403) and determine the target resource on the client computer based on the aforesaid portion of the banner ad activated by the user (step 404). The browser the loads the desired resource based on the URL (steps 405 and 406). This technique is called client-side processing. This technique is advantageous because no Internet communication with a remote server is required before the user's browser is re-directed to the target resource. The client-side processing can be achieved on a Java-enabled browsers, such as Microsoft Internet Explorer or Netscape Navigator by means of, for example, a Java script embedded into the source web page. Techniques for implementing such scripts are well-known to persons of skill in the art.

Specifically, the coordinates of the user's click will be passed to a script written in Java or a similar programming language, which would use those coordinates to determine the resource of interest to the user. Once that resource has been identified, the browser is re-directed by the aforesaid script to the appropriate URL. Also, the use of the browser is not necessary for the practice of the inventive methodology. Web pages may be accessed by the user using any other suitable means.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention.

For example, the script may be implemented in a wide variety of programming or scripting languages, such as C/C++, perl, shell, PHP, Java, etc.

Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for re-directing user browser to a network resource, said method comprising:
displaying a graphical advertising object on said browser, said graphical advertising object comprising a plurality of graphical primitives, each of said primitives associated with a link to one of a plurality of network resources;
detecting activation of a one of said plurality of graphical primitives of said graphical object by the user, and
using said link associated with the activated graphical primitive to redirect user browser to a corresponding network resource.

2. The method of claim 1, wherein the said graphical object comprises a banner advertising object.

3. A method for re-directing user browser to a network resource, said method comprising:
displaying a graphical advertising object on said browser, said graphical advertising object comprising a plurality of portions;
detecting a user event whereby a user activates one of said plurality of portions of said graphical object, said event being associated with an event information;
transmitting said event information to a remote server executing a program;
using said transmitted event information to determine a network resource requested by the user, said network resource being associated with network resource identifying information;
communicating said network resource identifying information to said user browser; and
loading said network resource based on said transmitted network resource identifying information.

4. The method of claim 3, wherein said program is a CGI script.

5. The method of claim 3, wherein said event information comprises event coordinates.

6. The method of claim 3, wherein said network resource identifying information comprises resource URL.

7. A method for re-directing user browser to a network resource, said method comprising:
displaying a graphical advertising object on said browser, said graphical advertising object comprising a plurality of portions;
detecting a user event whereby a user activates one of said plurality of portions of said graphical advertising object, said event being associated with an event information;
providing said event information to a program executing on said user browser;
using said transmitted event information to determine a network resource requested by the user, said network resource being associated with network resource identifying information;
furnishing said network resource identifying information to said user browser; and
loading said network resource based on said transmitted network resource identifying information.

8. The method of claim 7, wherein said program is a Java script.

9. The method of claim 7, wherein said event information comprises event coordinates.

10. The method of claim 7, wherein said network resource identifying information comprises resource URL.

11. A computer readable medium embodying a plurality of computer instructions for re-directing user browser to a network resource, said instructions comprising:
displaying a graphical advertising object on said browser, said graphical advertising object comprising a plurality of graphical primitives, each of said primitives associated with a link to one of a plurality of network resources;
detecting activation of a predetermined graphical primitive of said graphical object by the user, and
using said link associated with the activated graphical primitive to redirect user browser to a network resource.

12. The computer readable medium of claim 11, wherein the said graphical object comprises a banner advertising object.

13. A computer readable medium embodying a plurality of computer instructions for re-directing user browser to a network resource, said instructions comprising:
displaying a graphical advertising object on said browser, said graphical object comprising a plurality of portions;
detecting a user event whereby a user activates one of said plurality of portions of said graphical advertising object, said event being associated with an event information;
transmitting said event information to a remote server executing a program;
using said transmitted event information to determine a network resource requested by the user, said network resource being associated with network resource identifying information;
communicating said network resource identifying information to said user browser; and
loading said network resource based on said transmitted network resource identifying information.

14. The computer readable medium of claim 13, wherein said program is a CGI script.

15. The computer readable medium of claim 13, wherein said event information comprises event coordinates.

16. The computer readable medium of claim 13, wherein said network resource identifying information comprises a resource URL.

17. A computer readable medium embodying a plurality of computer instructions for re-directing user browser to a network resource, said instructions comprising:
displaying a graphical advertising object on said browser, said graphical advertising object comprising a plurality of portions;
detecting a user event whereby a user activates one of said plurality of portions of said graphical object, said event being associated with an event information;
providing said event information to a program executing on said user browser;
using said transmitted event information to determine a network resource requested by the user, said network resource being associated with network resource identifying information;
furnishing said network resource identifying information to said user browser; and
loading said network resource based on said transmitted network resource identifying information.

18. The computer readable medium of claim 17, wherein said program is a Java script.

19. The computer readable medium of claim 17, wherein said event information comprises event coordinates.

20. The computer readable medium of claim 17, wherein said network resource identifying information comprises resource URL.

21. A method for directing a user of a first Internet resource to a second Internet resource, said method comprising:
providing a graphical advertising object within said first internet resource, said graphical advertising object comprising a plurality of embedded links, wherein at least one of said plurality of embedded links points to said second Internet resource;
in response to said user activating said graphical object, determining whether said at least one of said plurality of embedded links has been activated; and
if at said at least one of said plurality of embedded links has been activated, directing said user to said second Internet resource.

22. A method for directing a user of a first Internet resource to a second Internet resource, said method comprising:
providing a graphical object within said first internet resource, said graphical object comprising a plurality of active areas, wherein each of said plurality of active areas being associated with a target Internet resource and wherein at least one of said plurality of active areas being associated with a said second Internet resource;
in response to said user activating said graphical object, determining whether said at least one of said plurality of active areas has been activated; and
if at said at least one of said plurality of active areas has been activated, directing said user to said second Internet resource.

23. A computer system comprising a central processing unit and a memory, said memory storing a set of instructions for re-directing user browser to a network resource, said instructions causing said computer system to:
display a graphical advertising object on said browser, said graphical advertising object comprising a plurality of graphical primitives, each of said primitives associated with a link to one of a plurality of network resources;
detect activation of a one of said plurality of graphical primitives of said graphical object by the user, and
use said link associated with the activated graphical primitive to redirect user browser to a corresponding network resource.

24. The computer system of claim 23, wherein the said graphical object comprises a banner advertising object.

25. A computer system comprising a central processing unit and a memory, said memory storing a set of instructions for re-directing user browser to a network resource, said instructions causing said computer system to:
displaying a graphical advertising object on said browser, said graphical advertising object comprising a plurality of portions;
detecting a user event whereby a user activates one of said plurality of portions of said graphical object, said event being associated with an event information;
transmitting said event information to a remote server executing a program;
using said transmitted event information to determine a network resource requested by the user, said network resource being associated with network resource identifying information;
communicating said network resource identifying information to said user browser; and
loading said network resource based on said transmitted network resource identifying information.

26. The computer system of claim 25, wherein said program is a CGI script.

27. The computer system of claim 25, wherein said event information comprises event coordinates.

28. The computer system of claim 25, wherein said network resource identifying information comprises resource URL.

29. A computer system comprising a central processing unit and a memory, said memory storing a set of instructions for re-directing user browser to a network resource, said instructions causing said computer system to:
displaying a graphical advertising object on said browser, said graphical advertising object comprising a plurality of portions;
detecting a user event whereby a user activates one of said plurality of portions of said graphical object, said event being associated with an event information;
providing said event information to a program executing on said user browser;
using said transmitted event information to determine a network resource requested by the user, said network resource being associated with network resource identifying information;
furnishing said network resource identifying information to said user browser; and
loading said network resource based on said transmitted network resource identifying information.

30. The computer system of claim 29, wherein said program is a Java script.

31. The computer system of claim 29, wherein said event information comprises event coordinates.

32. The computer system of claim 29, wherein said network resource identifying information comprises resource URL.
